(19) United States
(12) Patent Application Publication
(10) Pub. No.: US 2018/0082368 A1
(43) Pub. Date: Mar. 22, 2018

(54) SYSTEM AND METHOD FOR DETECTING FRAUDULENT ACCOUNT ACCESS AND TRANSFERS

(71) Applicant: Early Warning Services, LLC, Scottsdale, AZ (US)

(72) Inventors: Laura E. Weinflash, Scottsdale, AZ (US); Janis E. Simm, Scottsdale, AZ (US); Jinghong Qi, Austin, TX (US)

(21) Appl. No.: 15/826,229

(22) Filed: Nov. 29, 2017

Related U.S. Application Data
(63) Continuation of application No. 13/326,055, filed on Dec. 14, 2011.
(60) Provisional application No. 61/422,861, filed on Dec. 14, 2010.

(51) Int. Cl. G06Q 40/02; G06Q 20/40

(52) U.S. Cl. CPC G06Q 40/02; G06Q 20/4016

(57) ABSTRACT

Transfers of money into a recipient account are analyzed for risk of fraud by using a fraud monitoring system to analyze characteristics of the recipient account. The recipient account characteristics are stored in a central database, which has account data (for recipient accounts) contributed from a plurality of financial institutions that maintain such accounts. When a transfer is made or attempted, the stored characteristics of the recipient account are analyzed and a risk score is assigned to the transfer based on the recipient account. If the risk score indicates a suspicious or fraudulent transaction, an alert is provided. In an alternative embodiment, the risk analysis may be supplemented by analysis of transaction data association with the transfer.

### CROSS-REFERENCES TO RELATED APPLICATIONS

This application is a continuation of U.S. patent application Ser. No. 13/326,055 for SYSTEM AND METHOD FOR DETECTING FRAUDULENT ACCOUNT ACCESS AND TRANSFERS, filed Dec. 14, 2011, which claims the benefit of U.S. Provisional Patent Application No. 61/422,861 for SYSTEM AND METHOD FOR DETECTING FRAUDULENT ACCOUNT ACCESS AND TRANSFERS, filed Dec. 14, 2010, which are incorporated herein by reference for all purposes.

### BACKGROUND OF THE INVENTION

Financial institutions and their customers are subject to loss arising from the fraudulent transfer of money from customer accounts to an unauthorized persons or entities (such as identity thieves). In some circumstances, the fraudulent transfer occurs when a thief learns private information of a customer (such as an account number, account password, social security number, driver's license number) and then uses that information to gain unauthorized access to the customer's account. The thief will often transfer amounts from the customer account to another account controlled by the thief, so that the thief can thereafter withdraw and use the stolen amounts from the other account without attracting attention.

### BRIEF SUMMARY OF THE INVENTION

There is provided, in accordance with embodiments of the present invention, a system and method for detecting unauthorized transfers between accounts, such as a transfer from an account that has been subject to takeover by an unauthorized person (e.g., identity thief) to another account where the transferred amounts may be more freely withdrawn and used by the unauthorized person.

In one embodiment, a method for detecting unauthorized transfers between accounts includes receiving, from a plurality of institutions, account data associated with accounts maintained by the financial institutions, wherein the account data includes characteristics of each account, storing the account data in an account database, and analyzing, at a fraud monitoring system, the account data for at least one of the accounts to determine a risk score for that account when used as a recipient account, the risk score reflecting the risk that a transfer into the recipient account is unauthorized.

A more complete understanding of the present invention may be derived by referring to the detailed description of the invention and to the claims, when considered in connection with the Figures.

### BRIEF DESCRIPTION OF THE DRAWINGS

FIG. 1 is a block diagram of a financial network, where account information and transaction data are evaluated by a fraud monitoring system in order to assess the level of risk of unauthorized transfers of money.

FIG. 2 is a flow diagram illustrating the evaluation of financial transfers in accordance with one embodiment of the invention.

FIG. 3 is a block diagram of a computer system upon which various devices, systems, and processes described in conjunction with FIGS. 1 and 2 may be implemented

### DETAILED DESCRIPTION OF THE INVENTION

Embodiments of the invention enable financial institutions to identify unauthorized or fraudulent transactions involving a transfer of value from one account (sometimes referred to herein as a “transfer account” or an “originating account”) to another account (sometimes referred to herein as a “destination account” or “recipient account”). In some embodiments risk assessment is done by collecting a plurality of characteristics for accounts maintained by a plurality of institutions, and then analyzing and scoring the characteristics for each account in order to establish a risk level associated with that account. (when that account is used as a recipient account). Thus, when a transfer is made into one of the accounts, suspicious or fraudulent activity can be flagged or identified.

A variety of characteristics of recipient accounts can be used to assess risk (as will be described in detail later). However, for purposes of better understanding the broader aspects of the invention as just described, examples of characteristics can include the date the account was opened, the balance in the accounts, the individual(s) and business(s) named as account holders or otherwise associated with the account, the number and nature of previous transfers, the patterns of previous transfers into and out of the account, and so forth.

In some embodiments, a risk score may be based solely on an analysis of characteristics of recipient accounts. In other embodiments, a risk score may be determined at the time of a transaction, and based not only on the characteristics of the recipient account, but also on transaction data associated with the transfer into the recipient account. As examples only, such transaction data used for assessing risk can include the identity of the device used for the transaction (e.g., computer, mobile phone, ATM), the amount being transferred, the voiceprint associated with the person making the transfer (e.g., if made via phone), the email address provided in conjunction with the transfer, and so forth.

Also, while embodiments described herein relate to the transfer of money between financial accounts (such as checking accounts, savings accounts, brokerage accounts, money market accounts, and stored value accounts) maintained at financial institutions (such as banks, savings and loan companies, credit unions, investment firms, and money transfer institutions), it should be appreciated that other kinds of transactions, transferred values and accounts can be involved and have risk assessed using the present invention. As examples, either the originating account or recipient account could be a credit card account (e.g., money being credited from a credit card account into another credit card account or some other kind of account), a loyalty account (where loyalty points are being transferred), and so forth. Thus, in its broadest sense, embodiments can be used in any kind of transfer of value between any kind of account.

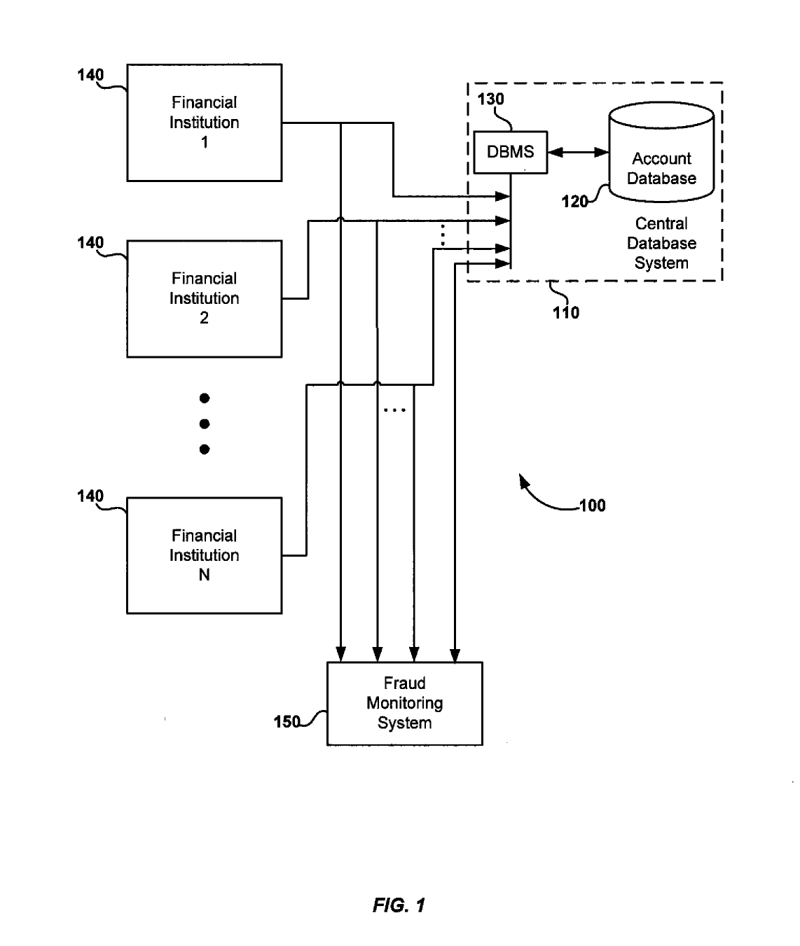

To better understand the invention through the description of a specific implementation, reference is made to FIG. 1, which is a block diagram illustrating an exemplary system 100 for detecting unauthorized or fraudulent transfers according to one embodiment of the present invention. As seen, the system 100 includes a central database system 110 having an account storage or database device 120 and a database management system (DBMS) 130. The database device 120 stores account and transaction information received from a plurality of financial institutions 140. The DBMS 130 manages the data in the database device 120 (e.g., stores, retrieves, arranges, sorts and processes the data in the database).

The nature of the information provided to and stored at database system 110 will be described in greater detail later, but briefly, financial institutions 140 will provide information in the form of account numbers (for many or all of accounts maintained at the institutions 140) and in the form of various details and characteristics of the accounts associated with each account number. It should be appreciated that such data may be provided by each financial institution on a regular and on-going basis so that it is kept current and up-to-date. A financial institution could transmit such data periodically (e.g., on a batch basis each day), to not only provide information on new accounts that may have opened since the last transmission, but to also update information on accounts for which information has been previously stored in database device 120. As will be described below, the characteristics of each account are used to determine a risk level (or score) associated with such account being used as a recipient account (an account into which a transfer is being made).

In some embodiments, the risk level may be determined without regard to the originating account (the account from which the money is being transferred), i.e., it is based solely on characteristics of the intended recipient account as may be received from the financial institution maintaining such account. In other embodiments, the risk level determination may further include an analysis of transaction data associated with the transfer (including, e.g., information on the originating account or the transferor).

Thus, in some embodiments, the financial institutions 140 will also provide transaction data when a transfer is being made from one account (at any one of the institutions 140) to another account (at the same or any other one of the institutions 140). Such information will include details or characteristics of the transfer that may have a bearing on whether the transfer is authorized. Such data may optionally be stored in database device 120 and not only used for analyzing a current transfer transaction (in addition to the characteristics of the recipient account), but also stored in database device 120 in order to determine a risk level or score for subsequent transfer transactions.

Table I below provides more detailed examples of recipient account characteristics that may be used in assessing the risk of transfers into a recipient account:

TABLE I
Recipient Account Characteristics

Name/ID of individual principal on account
Name/ID of business on account
Name/ID of signor to the account
Device associated with account
Prior unauthorized transactions, fraud or abuse associated with account
Prior unauthorized transactions, fraud or abuse associated with name of
account principal
Prior unauthorized transactions, fraud or abuse associated with name of
account business
Prior unauthorized transactions, fraud or abuse associated with device
associated with account
Account opened date
Account type
Prior returns for account
Account balance
Dollar amounts and dates of prior inflow and outflow transactions
Prior originating accounts used for deposits or transfers into account
Email address of account holder
Phone number related to transfer or account
Device location, device ID, IP Address, User Agent String

Table II below provides more detailed examples of transfer transaction characteristics that may be used in assessing the risk of transfers into a recipient account:

TABLE II
Transfer Transaction Characteristics

Name/ID of person requesting transfer
Dollar amount of transaction
Account number of originating account
Name on transfer (transferor)
Voice print of person requesting transfer (telephone)
Device used to request transfer
Email address used for requesting transfer
Phone used for requesting transfer

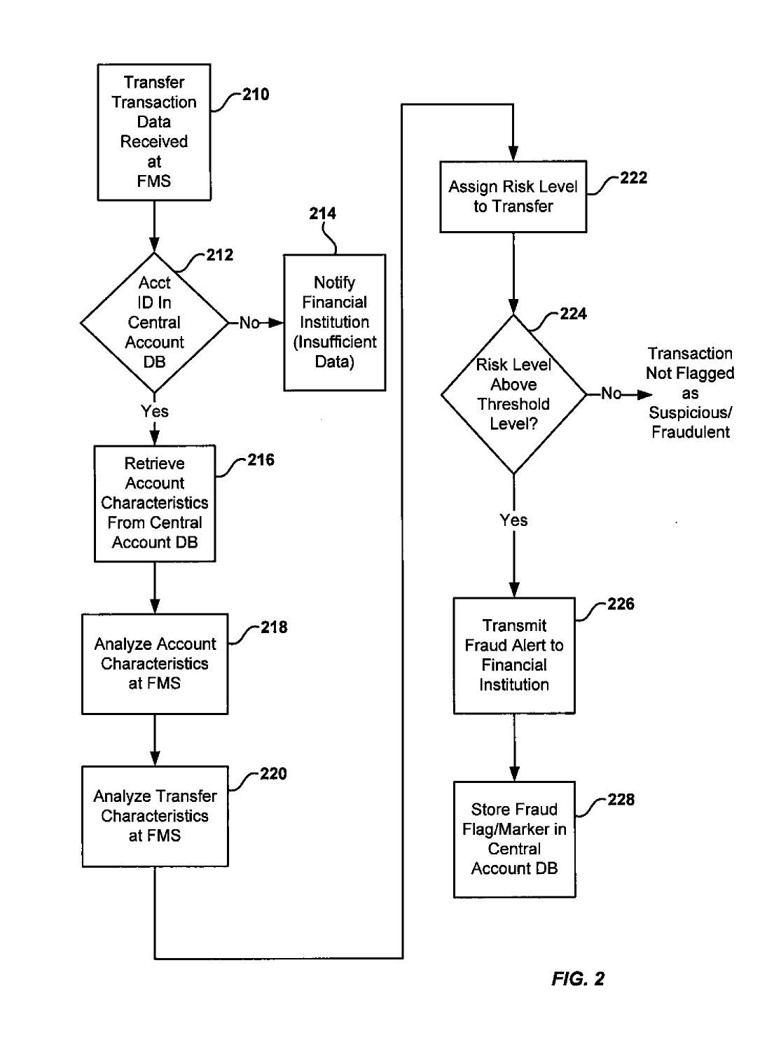

The system 100 in FIG. 1 further includes a fraud monitoring system 150. As will be described in greater detail below in conjunction with FIG. 2, when a transfer transaction is made (or intended to be made) at one of the financial institutions 140, transaction data (including the recipient account number/identifier) is provided by the financial institution having the originating account. The transaction data (including the recipient account number/identifier) is provided to the fraud monitoring system 150. The fraud monitoring system uses the recipient account number/identifier to either access the central database system 110 in order to retrieve characteristic data associated with the account (and then calculate a risk score on a real time basis), or in some embodiments, to access the central database system 100 in order to retrieve a risk score if it has been previously calculated and stored in database device 120. It should be appreciated that in order to completely identify the recipient account, the account identifier would include not only the actual account number for the recipient account, but also an identifier for the bank where the account is maintained (e.g., bank name, ABA number, routing and transit number, etc.). In embodiments where the financial institution also provides transaction data (beyond the recipient account identifier), the fraud monitoring system may also use transaction data to supplement recipient account characteristics in the database device 120, by using both the account characteristics of a recipient account and the transfer transaction characteristics to calculate a current risk score.

Turning now to FIG. 2, there is illustrated an exemplary flow or process for assessing the risk associated with a transfer to a recipient account. In the specific embodiment illustrated, the assessment occurs at the time that a transfer transaction takes place and the assessment includes both an assessment of recipient account characteristics and transfer transaction characteristics in order to arrive at a risk score or level. However, as mentioned earlier, in some embodiments at least part of the risk score associated with a recipient account may been previously determined or calculated using recipient account characteristics previously stored (and updated) in the database device 120, based on previous transfers of recipient account data from each of the financial institutions 140.

It is assumed for purposes of describing the process of FIG. 2 that recipient account numbers and recipient account characteristics have been stored at the central database system 110, the data having been previously transmitted as part of routine transmissions of data from each of the financial institutions 140. It is further assumed that the data is contributed from a large enough number of financial institutions that database system 110 is likely to have some characteristic data for most possible recipient accounts. As should be apparent, the completeness of the database 120 will be determined by the number of financial institutions contributing account information for their own accounts. However, the number of contributing institutions is likely to be large. Among other things, access to risk scores for recipient accounts will encourage many if not most financial institutions to contribute their own account data in order to reduce their own losses resulting from fraudulent transfers.

When a transfer transaction is requested involving an originating account at one of the financial institutions 140, that financial institution transmits transaction data, in the form of an account identifier (financial institution name or financial institution ABA number, and the recipient account number) and (in some cases) one or more transfer transaction characteristics (see Table II above), which is received at the fraud monitoring system (FMS) 150 at step 210. Although not illustrated in FIG. 2, the same transaction data (if it includes transfer characteristics) may also be provided from fraud monitoring system 150 to database system 110 (for storing in database device 120 and for subsequent use in calculating risk scores). The fraud monitoring system 150 accesses the database system 110 to determine if the recipient account for the transaction is stored in database device 120 (along with recipient account characteristics) at step 212. If the account number is not in database device 120 (or in some circumstances, if the account number is present but not enough associated characteristic data is available to assess the risk), the originating financial institution is notified that insufficient data is available to provide a risk score (step 214).

If the recipient account number is present within database device 120, the account characteristics stored in association with the account number are retrieved and sent to the fraud monitoring system 150 (step 216). Such retrieved characteristics are analyzed at step 218 by the fraud monitoring system 150. The fraud monitoring system then also analyzes (step 220) transfer characteristics (if any) associated with the transaction that were previously received from the financial institution at step 210. The fraud monitoring system then assigns a risk score or level (step 222) to the transfer, which in the illustrated embodiment may be based on either or both the risk associated with the recipient account as analyzed or assessed at step 218 and the risk associated with the specific transfer characteristics as analyzed or assessed at step 220.

The assigned risk score may be numerical (e.g., a number on a scale from 1 to 100), or may be more generally stated levels (e.g., low, medium and high). Various predictive or statistical models may be used in analyzing data and assigning risk scores. Preferred embodiments of those approaches are described as follows.

Risk Score Computation Through Linear Weighted Combination

In one embodiment, a risk score is computed through a linear combination of discrete risk parameters, weighted by their importance in determining the likelihood that a transaction or series of transactions is indicative of an account takeover event. In one format, an initial unsealed risk score may be computed as SCORE=A₁X₁+A₂X₂+A₃X₃+ . . . +AₙXₙ, where Xᵢ represent values of risk factors or parameters as expressed in Tables III and IV, and Ai represent weighted preselected but adjustable coefficients of the linear combination, and may be positive in sign (indicating that the value of a parameter term increases overall likelihood of risk, and such may be the case for parameter terms taken from Table III) or may be negative in sign (indicating that the value of its multiplied parameter decreases overall likelihood of risk, and such may be the case for parameter terms taken from Table IV). The values of individual parameters may be a binary 1 or 0 function (for example, parameter 1 in Table III may be “1” if a recipient account was associated with previous unauthorized transactions, fraud or abuse, and “0” otherwise) or parameters could be any other values such as integers, or real numbers (for example, parameter 1 in Table III may represent the actual number of times a recipient account was associated with previous unauthorized transactions, fraud or abuse, and would have a value of “0” for no detected fraud/abuse). The magnitude and sign of coefficients Aᵢ are selected based on any desired technique such as proposing trial coefficients for a known prior ATO-type (Account Takeover-type) transaction then adjusting the coefficients until an appropriate risk level is matched. Likewise, the coefficients of the formula may be evaluated by analyzing past transactions that were not indicative of an ATO-type event, and adjusting coefficients until a low risk score is produced. The linear combination result may be scaled to any appropriate range, for instance a 1-100 numerical scale, a binary scale, a discretized risk scale such as “low,” “medium,” or “high,” or any desired scaling range such as those other scales mentioned herein.

Those of skill in the art may appreciate that while a linear weighted combination is mentioned in this context, a nonlinear approach may be utilized as well, such as applying power exponents to individual parameters Xᵢ. Such exponential approaches may be particularly useful, for example, where individual parameters are found to be extremely sensitive indicators of risk, or may not show risk until their absolute value reaches some determined threshold.

Risk Score Computation Through Statistical Analysis and CART Methodology.

In another embodiment, a risk score model is created by using prior transaction data to model the risk of ATO-type transactions over a period of time using statistical regression analysis. In one embodiment, those risk parameters from transactions that are found to be indicative of risk may be submitted to a mathematical model to produce a risk score, such as if the parameters are weighted and combined to determine the risk score, and then the score may be scaled as mentioned above. In the alternative, a CART methodology (also known as binary recursive partitioning) may be used to recursively partition binary tree data structures applied against the transaction data set to identify parameters of risk associated with those transactions, and a mathematical model is built from the subsequent analysis. Cart Methodology is described in http://www.salford-systems.com/resources/whitepapers/overview-cart-methodology.html (“Salford Analytics and Data Mining Conference 2012”) and http://www.biostat.iupui.edu/˜XiaochunLi/BIOS %20621/ccsEd.pdf (“Tree-Based Methods,” by Adele Cutler, D. Richard Cutler, and John R. Stevens), the disclosures of which are fully incorporated by reference herein for all purposes.

Risk Score Computation Through Neural Network Approaches

In yet another embodiment, a risk scoring model is created through an artificial neural network approach, wherein a data set comprising known ATO-type transactions and their associated risk parameters as well as known non-ATO-type transactions and their associated risk parameters, are submitted to a multilayer neural network model, and through a conventional training technique, the network converges to produce a risk score that takes inputs of risk parameters from Tables III and IV and quantifies a risk score based on its previously trained network weights. In this manner, a highly nonlinear relationship between risk parameters may be represented without the need for significant manual adjustment of a linear combination formula. Neural network training and use approaches are discussed and referenced to in part in U.S. Pat. No. 7,545,965 (issued on Jun. 9, 2009, to Suzuki et al), and its cited references, the disclosures of which are incorporated by reference herein for all purposes.

The following Tables III and IV illustrates one model for analyzing the risk by assessing a number of factors/attributes, using recipient account characteristics and transfer transaction characteristics.

TABLE III
Exemplary Risk Factors
High risk factors/attributes

1. Recipient account is associated with previous unauthorized transactions, fraud or abuse
2. Recipient account principal is associated with previous unauthorized transactions, fraud or
abuse
3. Recipient account business is associated with previous unauthorized transactions, fraud or
abuse
4. Recipient device associated with the transaction is associated with previous unauthorized
transactions, fraud or abuse
5. Account was opened less than A months/years ago, where A is a predetermined length of time
6. Account type is irregular for the type of money transfer
7. Returns greater than X on this recipient account, where X is a predetermined number
8. Balance is less than $Y or out of pattern for the account, where $Y is a predetermined amount
9. Dollar amount of transactions is out of pattern
10. Number of deposits or transfers into this account from unique (not previously used)
originating accounts is greater than Z
11. Inflow and outflow of the transactions appears highly indicative of fraud
12. New signor to the account
13. Name on transfer doesn't match name on recipient account
14. For voice requests to transfer, the voice print has fraud or abuse match
15. Device for transfer matches recipient device
16. Email address on transfer doesn't match email address on transfer account
17. Relationship between sender and recipient is suspect
18. Recipient information is associated with fraud or abuse

TABLE IV
Exemplary Low (Negative) Risk Factors/Attributes

1. Recipient account is not associated with previous unauthorized transactions, fraud or abuse
2. Recipient account principal is not associated with previous unauthorized transactions, fraud or
abuse
3. Recipient account business is not associated with previous unauthorized transactions, fraud or
abuse
4. Recipient device associated with the transaction is not associated with previous unauthorized
transactions, fraud or abuse
5. Account was opened more than A months/years ago, where A is a predetermined length of
time
6. Account type is consistent for the type of money transfer
7. Returns less than X on this recipient account where X is a predetermined number
8. Balance is greater than $Y, where $Y is a predetermined amount
9. Dollar amount of transactions is in within pattern
10. Number of deposits or transfers into this account from unique accounts is less than Z, where
Z is a predetermined number
11. Inflow and outflow of the transactions doesn't appear indicative of fraud
12. No new signor to the account
13. Name on transfer matches name on account
14. Email address of transfer matches address on account
15. For voice requests to transfer, the voice print does not have fraud or abuse match
16. Recipient information is not associated with fraud or abuse

In one simple embodiment, where risk levels of low, medium and high are assigned to a transfer transaction, the use of the above factors may be unweighted. For example, if most of the analyzed factors are high risk factors, then a “high” level is assigned. If most of the analyzed factors are low risk factors, then a “low” level is assigned. If the analyzed factors are mixed, than a “medium” level is assigned. In other embodiments, the various risk factors in Tables III and IV may be weighted with some factors (e.g., the recipient account being associated with previous unauthorized transactions) being given more weight in determining risk than other factors (e.g., a newly opened account). Also, it should be appreciated that factors illustrated in Tables III and IV as including a variable (e.g., account was opened less than “A” months/years ago), would have the value of the variable (e.g., “A”) established in advance. The value might depend, for example, on the risk tolerance of the financial institution where the transfer originates.

Returning to FIG. 2, the fraud monitoring system next determines (step 224) whether the assigned risk level is above a threshold that has been established, for example, by the financial institution, by the legitimate account holder or by a risk management service. As a specific example, if an account holder has had previous experiences with fraudulent takeover of his/her account, the threshold may be set at low, and any transaction with an assigned medium or high risk level will be flagged, and a fraud alert is sent to the financial institution (step 226). While not shown in FIG. 2, alerts may also be sent directly to the account holder (e.g., at a known legitimate email address) or to law enforcement agencies. In this specific example, if the risk level is determined to be low, the transaction is not flagged at step 224.

Finally, at step 228, if a transaction is flagged as fraudulent (or suspicious) at step 224, then a flag or marker may be set in database 120 (as a new account characteristic) for use in analyzing future transfer transactions to the same account (e.g., a recipient account involved in an attempted fraudulent transaction may be more likely to be involved in future fraudulent transactions). Also, the financial institution in question may place a freeze on an originating account that has had an attempted fraudulent transaction, until the possible fraudulent takeover had been corrected or other remedial steps have been taken. The originating financial institution may use this information, either alone or in combination with other risk factors, to determine whether or not to transfer the funds to the recipient account (suspect account).

While the embodiment described in connection with FIG. 2 is generally directed to a single transaction (from one originating account to one recipient account), in other embodiments a similar process can be used in connection with multiple transfers (e.g., from multiple originating accounts to one or a few recipient accounts). Such a circumstance can arise with what is often referred to as a “money mule,” an individual hired by a criminal syndicate or enterprise to transfer money from a large number of originating accounts to an account or accounts designated by the syndicate. For example, if a large number of accounts have been compromised (e.g., a hacker gains access account numbers and passwords at a financial institution), a money mule will be hired to transfer money from those accounts in a short period of time to an account maintained (at least temporarily) by the syndicate. Thus, over a period of a few hours, one or more money mules will access and transfer a large amount of money from those compromised accounts to a recipient account (where the money will usually be withdrawn quickly by the syndicate). Embodiments of the present invention permit such transfers to be detected and the affected financial institution notified.

For example, the fraud monitoring system 150 can track suspicious transactions (e.g., each having a risk level above an established risk level) identified at step 224 in order to determine if money is being transferred from many different originating accounts to a single recipient accounts (or a few recipient accounts), indicating money mule activity and possible compromise of the originating accounts (especially when the multiple originating accounts are at a single financial institution).

In one embodiment, the fraud monitoring system 150 looks for recipient account markers that have been set at step 228, and identifies transition patterns at a recipient account involved in multiple suspicious transactions. If those transactions at the recipient account are over a short period of time (say one hour, four hours, twenty-four hours, or some other specified short period of time that would reflect money mule activity), then the fraud monitoring can transmit a fraud alert to the financial institution maintaining the originating accounts, indicting that its account records may have been compromised and possible money mule activity has taken place. The financial institution may take immediate steps to stop further transfers and to investigate, among other things, a possible breach in its security relating to the account information maintained within its systems.

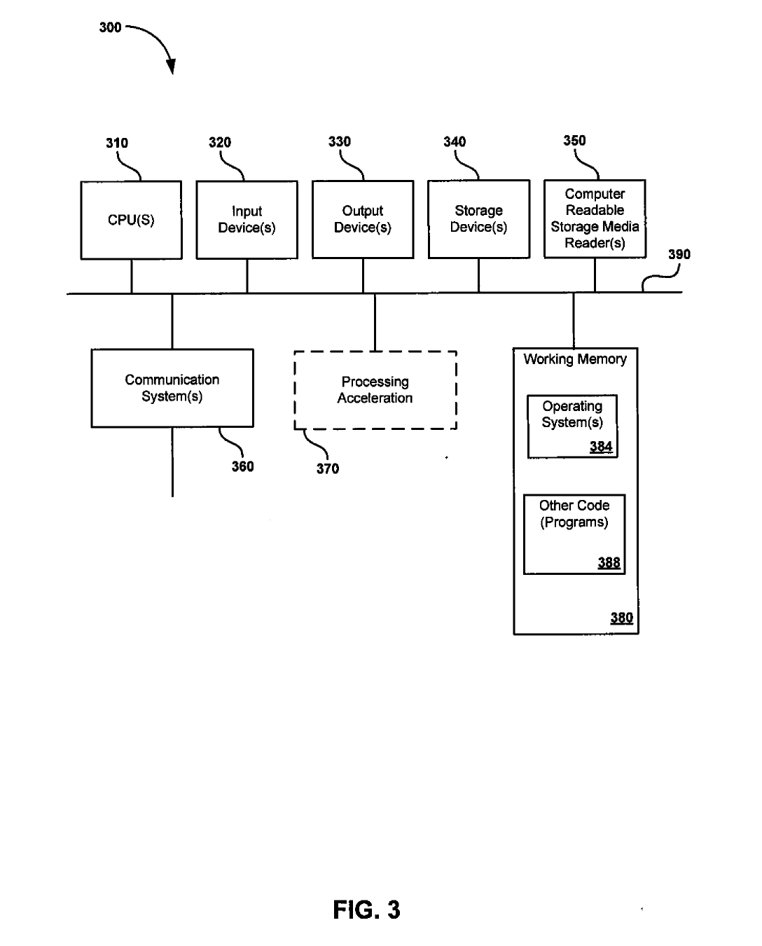

FIG. 3 is a block diagram illustrating an exemplary computer system upon which embodiments of the present invention may be implemented. This example illustrates a computer system 300 such as may be used, in whole, in part, or with various modifications, to provide the functions of the central database system 110 and the fraud monitoring system 150, as well as other components and functions of the invention described herein.

The computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage devices 340, representing remote, local, fixed, and/or removable storage devices and storage media for temporarily and/or more permanently containing computer-readable information, and one or more storage media reader(s) 350 for accessing the storage device(s) 340. By way of example, storage device(s) 340 may be disk drives, optical storage devices, solid-state storage device such as a random access memory (“RAM”) and/or a read-only memory (“ROM”), which can be programmable, flash-updateable or the like.

The computer system 300 may additionally include a communications system 360 (e.g., a modem, a network card—wireless or wired, an infra-red communication device, a Bluetooth™ device, a near field communications (NFC) device, a cellular communication device, etc.) The communications system 360 may permit data to be exchanged with a network, system, computer, mobile device and/or other component as described earlier. The system 300 also includes working memory 380, which may include RAM and ROM devices as described above. In some embodiments, the computer system 300 may also include a processing acceleration unit 370, which can include a digital signal processor, a special-purpose processor and/or the like.

The computer system 300 may also comprise software elements, shown as being located within a working memory 380, including an operating system 384 and/or other code 388. Software code 388 may be used for implementing functions of various elements of the architecture as described herein. For example, software stored on and/or executed by a computer system, such as system 300, can be used in implementing the process seen in FIG. 2.

It should be appreciated that alternative embodiments of a computer system 300 may have numerous variations from that described above. For example, customized hardware might also be used and/or particular elements might be implemented in hardware, software (including portable software, such as applets), or both. Furthermore, there may connection to other computing devices such as network input/output and data acquisition devices (not shown).

While various methods and processes described herein may be described with respect to particular structural and/or functional components for ease of description, methods of the invention are not limited to any particular structural and/or functional architecture but instead can be implemented on any suitable hardware, firmware, and/or software configuration. Similarly, while various functionalities are ascribed to certain individual system components, unless the context dictates otherwise, this functionality can be distributed or combined among various other system components in accordance with different embodiments of the invention. As one example, the central account database system 110 system and fraud monitoring system 150 may be implemented by a single system having one or more storage device and processing elements. As another example, the central account database system 110 system and fraud monitoring system 150 may each be implemented by plural systems, with their respective functions distributed across different systems either in one location or across a plurality of linked locations.

Moreover, while the various flows and processes described herein (e.g., those illustrated in FIG. 2) are described in a particular order for ease of description, unless the context dictates otherwise, various procedures may be reordered, added, and/or omitted in accordance with various embodiments of the invention. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments may be described with (or without) certain features for ease of description and to illustrate exemplary features, the various components and/or features described herein with respect to a particular embodiment can be substituted, added, and/or subtracted to provide other embodiments, unless the context dictates otherwise. Consequently, although the invention has been described with respect to exemplary embodiments, it will be appreciated that the invention is intended to cover all modifications and equivalents within the scope of the following claims.

What is claimed is:

1. A breach detection system for detecting breach at a financial institution of systems having data for accounts of customers maintained at the financial institution, comprising:
a central database;
a database management system (DBMS) for managing the central database, the DBMS receiving, from a plurality of financial institutions, account data associated with accounts maintained by the financial institutions, wherein the account data includes characteristics of each account, the DBMS storing the received account data in the central database;
a monitoring system, the monitoring system (1) receiving transfer transaction data from the financial institutions for transfer transactions processed at the financial institutions, each transfer transaction associated with the transfer of value from an originating account to a recipient account, wherein the transaction data includes data identifying the recipient account and the originating account associated with the transfer transaction, wherein the originating account is held by a customer of a financial institution and is subject to being fraudulently taken over by an unauthorized person in order to conduct an unauthorized transfer to the recipient account, and wherein the recipient account is subject to being controlled by the unauthorized person (2) analyzing the account data stored in the account database for at least one of the accounts, to determine a risk score for that account as a recipient account, the risk score reflecting the risk that a transfer into the recipient account is unauthorized, (3) when the risk score for an account as a recipient account reflects that a transfer transaction associated with that recipient account is unauthorized, storing in the account database, in association with the recipient account, a fraud flag; (4) monitoring the account database for fraud flags; and (5) if a plurality of fraud flags are stored in association with at least one recipient account receiving value associated with transfer transactions from multiple originating accounts maintained by the same financial institution to that at least one recipient account, notifying the financial institution maintaining the multiple originating accounts of possible compromise of multiple accounts at that financial institution.

2. The system of claim 1, wherein the monitoring system notifies the financial institution maintaining the multiple originating accounts of possible compromise of multiple accounts at that financial institution when the plurality of flags are stored in the account database for transactions conducted over a specified period of time.

3. The system of claim 2, wherein the specified period of is selected from a group comprising one hour, four hours, or twenty-four hours.

4. The system of claim 1, wherein the risk score is determined at the time that a transfer is made from the originating account to the recipient account.

5. The system of claim 4, wherein the monitoring system analyzes transaction data associated with the transfer made from the originating account to the recipient account, along with the account data, to determine a risk score for that account used as a recipient account.

6. The system of claim 1, wherein the risk score is determined as account data is stored in the account database, in advance of the transfer into the recipient account.

7. The system of claim 1, wherein a plurality of high risk factors are associated with account data and transaction data and a plurality of low risk factors associated with account data and transaction data, and wherein the monitoring system determines which of the high risk factors and low risk factors are present and assigns the risk score based on the presence of high risk factors and low risk factors.

8. The system of claim 7, wherein the high risk factors and low risk factors are weighted, and wherein the weighted risk factors are used in assigning a risk score.

9. The system of claim 1, wherein the monitoring system determines a risk score by establishing a plurality of risk factors and using a linear combination of values assigned to the risk factors.

10. The system of claim 1, wherein the monitoring system determines a risk score by establishing a plurality of risk factors and using a statistical regression analysis for values assigned to the risk factors.

11. The system of claim 1, wherein the monitoring system determines a risk score by establishing a plurality of risk factors and using binary recursive partitioning to identify the risk factors associated with the transfer into the recipient account.

12. The system of claim 1, wherein the monitoring system determines a risk score by establishing a plurality of risk factors and using an artificial neural network that receives the risk factors and quantifies the risk score based on previously trained neural network weights.

13. A breach detection method for detecting breach of systems at a financial institution having data for accounts of customers maintained at the financial institution, the method comprising:
providing a central database, a database management system (DBMS) for managing the database, and a monitoring system;
receiving at the DBMS, from a plurality of financial institutions, account data associated with accounts maintained by the financial institutions, wherein the account data includes characteristics of each account;
storing in the central database the account data received at the DBMS;
receiving at the monitoring system, from the financial institutions, transfer transaction data for transfer transactions processed at the financial institutions, each transfer transaction associated with the transfer of value from an originating account to a recipient account, wherein the transaction data includes data identifying the recipient account and the originating account associated with the transfer transaction, wherein the originating account is held by a customer of a financial institution and is subject to being fraudulently taken over by an unauthorized person in order to conduct an unauthorized transfer to the recipient account, and wherein the recipient account is subject to being controlled by the unauthorized person;
analyzing, at the monitoring system, the account data stored in the account database for at least one of the accounts, to determine a risk score for that account as a recipient account, the risk score reflecting the risk that a transfer into the recipient account is unauthorized;
when the risk score for an account as a recipient account reflects that a transfer transaction associated with that recipient account is unauthorized, storing in the account database, in association with the recipient account, a fraud flag;
monitoring, at the monitoring system, the account database for fraud flags; and
if a plurality of fraud flags are stored in association with at least one recipient account receiving value associated with transfer transactions from multiple originating accounts maintained by the same financial institution to that at least one recipient account, notifying, by the monitoring system, the financial institution maintaining the multiple originating accounts of possible compromise of multiple accounts at that financial institution.

14. The method of claim 13, wherein the step of notifying a financial institution further comprises notifying the financial institution when the plurality of flags are stored in the account database for transactions conducted over a specified period of time.

15. The method of claim 14, wherein the specified period of is selected from a group comprising one hour, four hours, or twenty-four hours.

16. The method of claim 13, wherein the risk score is determined at the time that a transfer is made from the originating account to the recipient account.

17. The method of claim 16, further comprising:
analyzing, at the fraud monitoring system, transaction data associated with the transfer made from the originating account to the recipient account, along with the account data, to determine a risk score for that account used as a recipient account.

18. The method of claim 13, wherein the risk score is determined as account data is stored in the account database, in advance of the transfer into the recipient account.

19. The method of claim 13, further comprising:
providing a plurality of high risk factors associated with account data and transaction data;
providing a plurality of low risk factors associated with account data and transaction data;
determining which of the high risk factors and low risk factors are present; and
assigning the risk score based on the present high risk factors and low risk factors.

20. The method of claim 19, wherein the high risk factors and low risk factors are weighted, and wherein the weighted risk factors are used in assigning a risk score.
